(19) United States
(12) Patent Application Publication
(10) Pub. No.: US 2024/0269648 A1
(43) Pub. Date: Aug. 15, 2024

(54) BLOCK COMPOSITE MATERIAL FOR GAS ACCUMULATION AND METHOD OF PRODUCTION THEREOF

(71) Applicant: PUBLICHNOE AKTSIONERNOE OBSCHESTVO "GAZPROM", Saint-Petersburg (RU)

(72) Inventors: Anatolii Alekseevich FOMKIN, Moscow (RU); Aslan Usupovich TSIVADZE, Moscow (RU); Marina Konstantinovna KNIAZEVA, Krasnodarskii Krai (RU); Olga Viacheslavovna SOLOVTSOVA, Moscow (RU); Andrei Viacheslavovich SHKOLIN, Khimki (RU); Ilia Evgenevich MENSHCHIKOV, Moscow (RU); Oleg Yevgenievich AKSIUTIN, Moscow (RU); Aleksandr Gavrilovich ISHKOV, Moscow (RU)

(21) Appl. No.: 18/564,747

(22) PCT Filed: Oct. 21, 2022
(86) PCT No.: PCT/RU2022/000320

§ 371 Date: Nov. 28, 2023

(30) Foreign Application Priority Data
Nov. 30, 2021 (RU) 2021135367

(51) Int. Cl. B01J 20/20; B01J 20/22; B01J 20/28; B01J 20/30

(52) U.S. Cl. CPC B01J 20/205; B01J 20/226; B01J 20/2808; B01J 20/3007; B01J 20/3042; B01J 20/3078; B01J 2220/46

(57) ABSTRACT

The group of inventions relates to the method of production of the block composite material for accumulation of gases containing organometallic coordination polymer and carbon material with increased pour density and bimodal pour distribution efficient for gas storage. The proposed method includes mixing of initial components, organometallic coordination polymer, carbon-containing material (microporous carbon adsorbent, carbon nanotubes, graphenes, graphitized black), binder solution like polyvinyl alcohol, chitosan solution in acetic acid, oxyethylcellulose; molding of the prepared mixture under pressure into blocks, drying and activation of blocks. The proposed block composite materials make it possible to increase efficiency and reliability of accumulation systems of complex gas mixtures when operating in wide ranges of temperature and pressure due to availability of at least two pore modes, each of which is capable of accumulation of gas with maximum efficiency at the specific thermodynamic parameters: temperature and pressure.

This group of inventions relates to the field of storage of gases, storage and separation of complex gas mixtures and methods of production of materials for storage and separation of gases.

Due to large area of surface, up to 10,000 m²/g, organometallic coordination polymer (OMCP) may be in high demand for use in gas storage or separation. But synthesized OMCPs are generally crystal powders with size of crystals from nanometers to hundreds of micrometers. Use of powdered adsorbents under dynamic conditions is disadvantageous due to occurrence of pressure difference when gas passes through the layer, dusting, wearing, carrying over with flow, difficulties in transportation and machining. Synthesized OMCPs are molded into compact forms of granules, spheres, tablets, etc. for efficient use. Moreover, OMCPs in pure form are mechanically and thermally unstable due to machining, impact of adsorption-desorption cycles, thermal effects of adsorption process. Therefore, OMCP-based composite materials are more efficient in gas storage and separation systems.

The known invention of U.S. Pat. No. 9,370,771 B2, IPC B01D53/04; B01J31/16; C10L3/10; B01D53/02; B01J20/02; B01J20/22; B01J20/28; B01J20/30 published on 21 Jun. 2016 provides a method of preparation of the molded OMCP blocks on the basis of aluminum obtained by solvothermal synthesis with use of solvent, water, mixed with at least one additional substance, binder, and extrusion of the obtained composition into the molded OMCP blocks. Analysis of examples of this invention shows that the specific surface of obtained materials is 1,000 m²/g in average that demonstrates reduction of its specific surface in relation to the known data on OMCP on the basis of aluminum.

The invention of U.S. Pat. No. 9,757,710 B1, IPC B01J20/22; B01J20/28; B01J20/30; C01B3/00; C10L3/06 published on 12 Sep. 2017 provides a method of compaction of the OMCP powder, where OMCP synthesized during application of the first solvent is filled with solvent capable to replace the first one at least to 10% of pore volume, thereafter OMCP is compacted and then dried until the solvent is removed. The authors state that the OMCP blocks preserve at least 80-90% of the specific surface and density of blocks is less than 60% of theoretical density of crystal structure of OMCP packed into the blocks depending on synthesis and compaction conditions. Disadvantage of the invention is narrow range of pore characteristics and ambiguousness of the OMCP service conditions.

The closest prior art of the claimed OMCP-based material provides a method of molded body production in the form of sphere including mixing of a composition containing organometallic composite polymer and at least one liquid and at least one additive containing a binder selected from the group consisting of non-organic oxides, aluminum oxide, clays, bentonite and concrete, as well as additives containing expanding agent selected from the group consisting of organic polymers, for example, from the group consisting of methylcellulose and polyethylene oxide or mixtures thereof (WO 2014118054 A1 IPC B01J2/06; B01J2/14; B01J20/22; B01J20/28; B01J20/30 published on 7 Aug. 2014).

Such approach allows creation of OMCP and composite materials containing spherical OMCP granules with increased pour density. Use of expanding agent during OMCP compaction allows grading of porous structure degradation caused by machining (pressing, extrusion) and filling of pores with a binder owing to additional porosity created by expanding agent. The disadvantage of this method is reduction of the specific surface of pores and, as a result, efficiency of gas accumulation due to the fact that the pores formed by expanding agent relate to macropores and mesopores, i.e. they are insufficient for adsorption and storage of complex gas mixtures.

The closest analog of the claimed method of gas mixture storage recommended for use in the storage systems of gas mixtures, in particular, natural gas, methane is RU 2650012, IPC F17C 11/00 (2006.01); B82B 1/00 (2006.01) published on 6 Apr. 2018, where nanoporous material with average effective width of pores from 0.6 to 1.2 nm is used during operation of accumulator container at operating pressure of 3.5 MPa and temperatures from plus 10 to plus 30° C. Nanoporous material with average effective width of pores from 0.5 to 1.0 nm is used during operation of accumulator container at operating pressure from 7 MPa and at the same temperatures. During operation of accumulator container in the lower temperature area, from minus 30 to minus 10° C., efficient accumulation may be obtained, if adsorbent with wider pores, from 0.9 to 2 nm, is used. Herewith, volume of adsorbent pores W₀ in accumulation system shall be maximum possible. Disadvantage of this known method is low efficiency of complex gas mixture storage due to narrow operating range of process parameters (temperature and pressure), at which each of the proposed materials is efficient.

Creation of composite materials on the basis of adsorbents with bimodal pore distribution is provided to solve the problem of efficient gas storage and maximum full accumulation of different components of complex gases. Such composite materials may be used, for example, in case of natural gas adsorption, where smaller mode will predominantly accumulate methane and larger one will accumulate heavier hydrocarbons. The mode corresponds to efficient inner diameter of micropore, nm. However, achievement of bimodal pore distribution in such a way that two modes have effective inner diameter of less than 2.0 nm and volume of their pores are comparably equal is difficult. Composite materials on the basis of OMCP and carbon adsorbents may solve this problem and at the specific ratio of components and parameters of porous structure they can ensure optimal ratio of adsorption and mechanical properties required for usage in gas storage and separation systems.

Therefore, task of this group of inventions is to obtain mechanically tenacious composite materials with sizes of pores efficient for accumulation of gases and mixtures, having developed inner surface, flexibly adapting to changes of phase composition and other characteristics of complex gas mixture when operating in wide ranges of temperatures and pressures.

The technical result to be achieved by the group of inventions is:
increase of pour density of block composite material by means of molding preserving developed inner surface, which will make it possible to increase the specific volume of gas accumulation in storage system volume unit ensuring the possibility of design of more compact gas storage system;
increase of hardness of the obtained block composite material by optimization of composition formulation and technology of its mixing to ensure possibility of industrial application of OMCP under conditions of increased aerodynamic loading;
decrease of gas losses at temperature and pressure disturbances in the gas storage system by means of bimodal pore size distribution of block composite material.

The technical result is achieved by the fact that, the method of block composite material production for accumulation of gases comprising mixing of components with binder, molding of the obtained mixture into blocks and their subsequent drying; organometallic coordination polymer and nanoporous carbon adsorbent or adsorbent on the basis of carbon nanotubes, which is mixed in ratio from 30/70 to 95/5% wt are used as components; effective inner diameters of micropores of the mixed components differ from one another by 0.4 nm minimum and 0.8 nm maximum; 2-15% water solution of compounds like polyvinyl alcohol, chitosan solution in acetic acid, oxyethylcellulose is used as binder; the obtained mixture is molded under the pressure into blocks within 1-2 minutes with loading force from 25 to 75 kN; blocks are placed in drying chamber at normal conditions; thereafter temperature is increased to 110-120° C. with a rate of 60 deg/h maximum and dry for 12 h minimum and 36 h maximum; then blocks are activated in thermal vacuum chamber at a temperature of 120° C. during 6 h minimum at a residual pressure of 0.26 kPa.

The technical result is achieved by the fact that block composite material for gas accumulation containing organometallic coordination polymer, nanoporous carbon adsorbent or adsorbent on the basis of carbon nanotubes in ratio from 30/70 to 95/5% wt respectively and binder, 2-15% water solution of compounds like polyvinyl alcohol, chitosan solution in acetic acid, oxyethylcellulose, characterized in that pour density of block composite material is in the range from 0.540 to 1.220 g/cm³, nanoporous structures is bimodal, effective inner diameters of micropores are comparable with initial components and differ from one another by 0.4 nm minimum and 0.8 nm maximum, material is used at temperatures from minus 30 to plus 60° C. and pressures of up to 10 MPa.

T1, T6 and CNT microporous carbon adsorbents were used as carbon component of composite material. T1 and T6 were obtained from peat by its mixing with potassium sulphide, subsequent granulation and carbonization by exhaust gases or pyrolysis gas, followed by the activation process at a temperature of 800° C. and milling to fracture size of >0.2 mm. Micro-mesoporous CNT carbon adsorbent containing carbon nanotubes was produced by “NanoTechCenter” Ltd. (Tambov) under commercial name of MPU-007. Porous structure parameters of the specified carbon components are given in Table 1.

Diluted (2-5%) solutions of PVAL, chitosan, oxycellulose were used as the composite material binder ensuring inhibition minimization of block composite material micropores by the binder in providing its acceptable strength.

Essence of the group of inventions is explained by detailed description of particular exemplary embodiments, as well as accompanying illustrations and tables that, however, do not limit the present group of inventions:
Table 1—parameters of porous structure of carbon materials used for molding of composite adsorbents, where: S_{BET}-specific surface area as per BET method, m²/g; W₀-specific micropore volume, cm³/g; D—effective inner diameter of micropores, nm; a₀—limit value of adsorption in micropores, mmol/g; E₀—nitrogen adsorption characteristic energy, kJ/mol; E—benzene adsorption characteristic energy, kJ/mol; WS—summarized pore volume, cm³/g; Wₘₑ—mesopore volume, cm³/g; Sₘₑ—mesopore area, m²/g.
Table 2—properties of composite materials on the basis of OMCP and carbon adsorbents molded using binder, where: S_{BET}-specific surface area as per BET method, m²/g; W₀—specific micropore volume, cm³/g; P—molding pressure, kN; t—molding time, minutes; ρ—pour density, g/cm³; W₀-specific micropore volume, cm³/g; D—effective inner diameter of micropores, nm; HA—hardness (Shore), ShA; HB—hardness (Brinell), kg/mm².

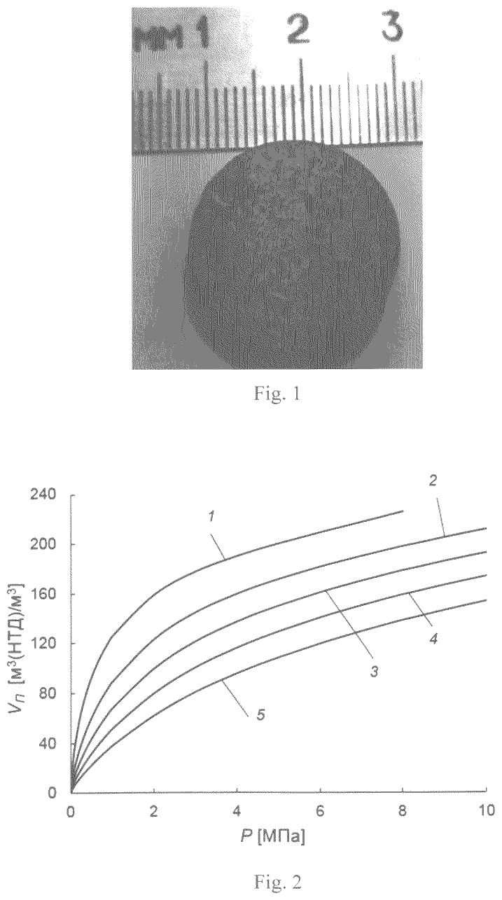

FIG. 1—photographic image of F-18 block composite material;

FIG. 2—specific methane amount that can be accumulated by F-18 block composite material at the following temperatures, ° C.: 1—minus 30; 2—0; 3—plus 20; 4—plus 40 and 5—plus 60;

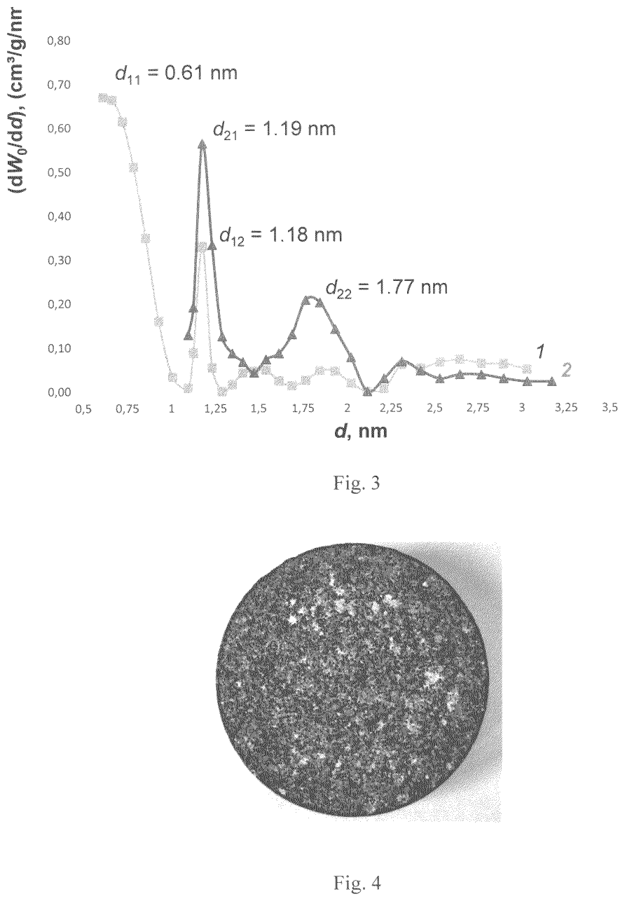

FIG. 3—bimodal micropore size distribution of samples of F-18 and F-63 composite material, Table 2, determined by NLDFT method as per isotherm of standard nitrogen vapor at 77 K, where: d_{11, 12}, d_{21, 22}—mode sizes of F-18 and F-63 respectively.

FIG. 4—photographic image of F-41 block composite material;

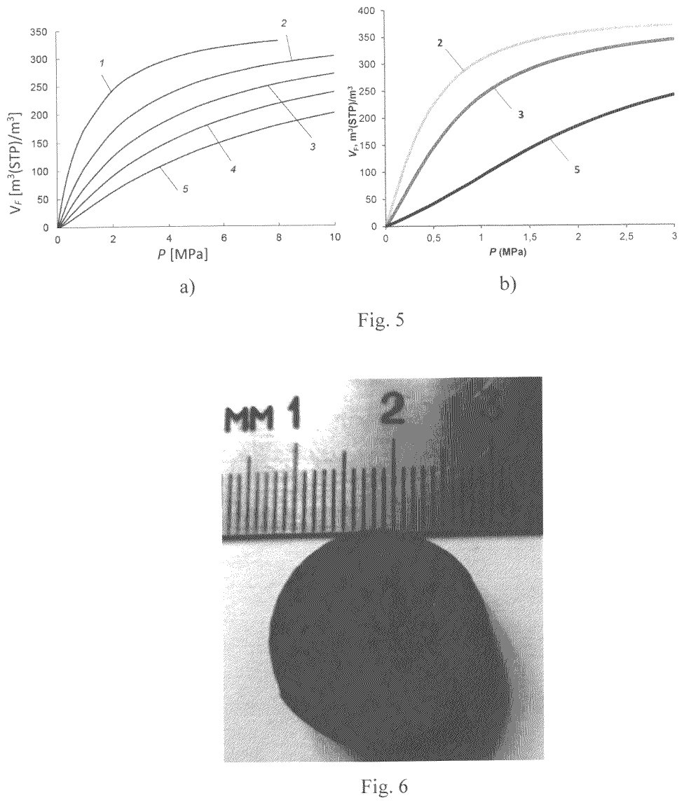

FIG. 5—specific amount of: a) methane, b) CO₂, accumulated by F-41 block composite material at the following temperatures, ° C.: 1—minus 30; 2—0; 3—plus 20; 4—plus 40 and 5—plus 60.

FIG. 6—photographic image of F-27 block composite material;

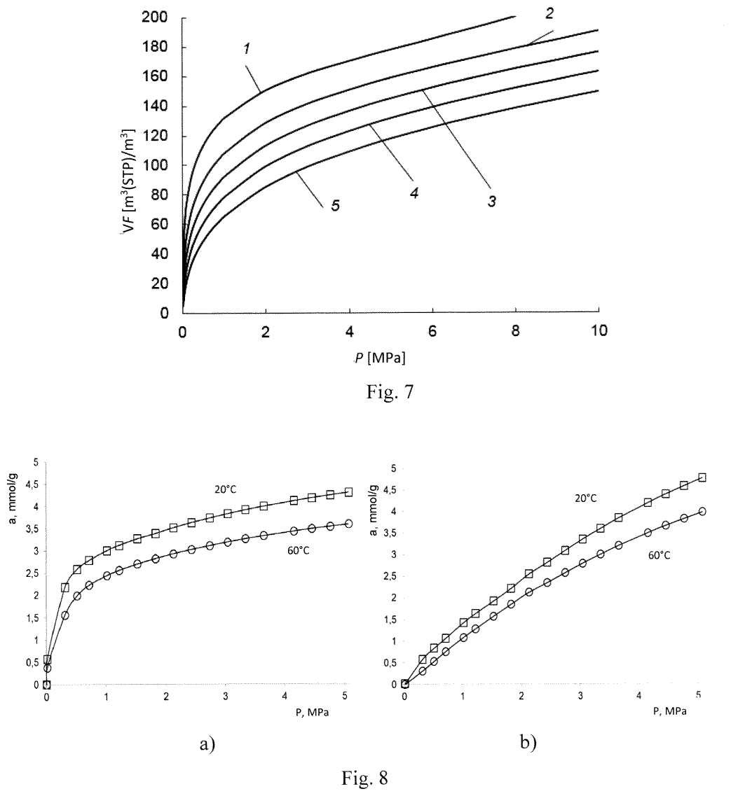

FIG. 7—specific methane amount that can be accumulated by F-27 block composite material at the following temperatures, ° C.: 1—minus 30; 2−0; 3—plus 20; 4—plus 40 and 5—plus 60;

FIG. 8—adsorption of mixture of methane and n-propane in volume concentration of 95/5% on composite material: a) F-27; b) F-41 at plus 20 and plus 60° C.

### Essence of the Group of Inventions is Illustrated by the Following Parameters: Example 1

CuBTC organometallic coordination polymer with effective inner diameter of micropores of 0.68 nm were mixed with T6 nanoporous carbon adsorbent with effective inner diameter of micropores of 1.34 nm in a ratio of 30/70% wt, binder, 5% water solution of polyvinyl alcohol, was added, homogenization was performed, whereupon the mixture was molded under pressure with loading force of 50 kN within 1 minute. The obtained blocks of composite materials were placed in drying chamber at room temperature, temperature was increased to plus 120° C. with a rate of 60° C./h maximum and they were held within 36 hours, then they were activated in thermal vacuum chamber at a temperature of 120° C. within 6 hours at a residual pressure of up to 0.26 kPa.

Obtained F-18 block composite material, FIG. 1, has bimodal porous structure of initial mixture components, pour density of 0.65 g/cm³. Thermal vacuum activation makes it possible to preserve characteristics of porous bimodal structure intrinsic to initial composite components in the most careful manner and clean out the inner surface of material for its subsequent intended use as the accumulator of gas mixtures. Methane amount accumulated by this adsorbent within the range of temperatures from minus 30 to plus 60° C. at pressures of up to 10 MPa is presented in FIG. 2; properties of the used carbon components are given in Table 1; properties of OMCP and obtained F-18 composite material are given in Table 2.

### Example 2

AlBTC organometallic coordination polymer with effective inner diameter of micropores of 1.74 nm were mixed with T6 nanoporous carbon adsorbent with effective inner diameter of micropores of 1.34 nm in a ratio of 50/50% wt, binder, 5% water solution of polyvinyl alcohol, was added, homogenization was performed, whereupon the mixture was molded under pressure with loading force of 75 kN within 2 minutes. The obtained blocks of composite materials were placed in drying chamber at room temperature, temperature was increased to plus 110° C. with a rate of 60° C./h maximum and they were held within 24 hours, then they were activated in thermal vacuum chamber at a temperature of 110° C. within 8 hours at a residual pressure of up to 0.26 kPa.

Obtained F-41 block composite material, FIG. 4, has bimodal porous structure of initial mixture components and its pour density is 0.65 g/cm³. Methane amount accumulated by this adsorbent within the range of temperatures from minus 40 to plus 50° C. at pressures of up to 10 MPa is given in FIG. 4; properties of the used carbon components are given in Table 1; properties of OMCP and obtained F-41 composite material are given in Table 2.

### Example 3

CuBTC organometallic coordination polymer with effective inner diameter of micropores of 0.68 nm were mixed with CNT nanoporous carbon adsorbent with effective inner diameter of micropores of 1.48 nm in a ratio of 90/10% wt, binder, 5% water solution of polyvinyl alcohol, was added, homogenization was performed, whereupon the mixture was molded under pressure with loading force of 75 kN within 1 minute. The obtained blocks of composite material were placed in drying chamber at room temperature, temperature was increased up to plus 120° C. with a rate of 60° C./h maximum and then they were dried within 36 hours, then they were activated in thermal vacuum chamber at a temperature of 120° C. within 10 hours at a residual pressure of up to 0.26 kPa.

Obtained F-27 block composite material, photographic image of which is presented in FIG. 6, has bimodal porous structure of initial mixture components. Its pour density is 0.77 g/cm³. Methane amount that can be accumulated by this adsorbent within the range of temperatures from minus 40° C. to plus 50° C. at pressures of up to 10 MPa is given in FIG. 6; properties of the used carbon components are given in Table 1; properties of OMCP and obtained F-27 composite material are given in Table 2.

### Example 4

It differs from Example 1 by the fact that 2% water solution of chitosan was added to adsorbent mixture. The obtained block composite material has adsorption characteristics identical to the one of materials in Example 1. Its pour density is 0,760 g/cm³. Properties of the used carbon components are given in Table 1; properties of OMCP and obtained F-111 composite material are given in Table 2.

### Example 5

It differs from Example 1 in the fact that 2% solution of oxycellulose was added to the adsorbent mixture and molding with loading force of 75 kN. The obtained block composite material has adsorption characteristics identical to the one of materials in Example 1. Its pour density is 1.200 g/cm³. Properties of the used carbon components are given in Table 1; properties of OMCP and obtained F-116 composite material are given in Table 2.

The obtained composite material in the group of inventions has bimodal porous structure with micropores and mesopores, press molded into compact blocks with a strength making it possible to use them as accumulators of gases and gas mixtures, for example, methane, nitrogen, carbon dioxide, natural gas, associated petroleum gases, allowing achievement of the claimed technical result. Bimodal pore distribution facilitates fast adaptation of gas storage to change of phase composition of complex gas mixture caused by process operations or weather condition change, because, in this case, different pore modes are used. As a result, gas losses due to discharging from safety valves are reduced. Increase of pour density of block composite materials makes it possible to increase the specific volume of gas accumulation in storage system volume unit for the possibility of design and construction of more compact storage systems of complex gas mixtures.

TABLE 1

| Carbon | | E₀, | | a₀, | E, | | | | Wₘₑ, |
|---|---|---|---|---|---|---|---|---|---|
| com- | W₀, | kJ/ | D, | mmol/ | kJ/ | S_{BET}, | Wₛ, | Sₘₑ, | cm³/ |
| ponent | cm³/g | mol | nm | g | mol | m²/g | cm³/g | m² | g |
| T1 | 0.61 | 19.11 | 0.63 | 17.45 | 6.31 | 1480 | 0.81 | 86.4 | 0.20 |
| CNT | 0.94 | 16.81 | 0.71 | 27.13 | 5.55 | 2760 | 2.05 | 401.1 | 1.09 |
| T6 | 0.66 | 17.89 | 0.67 | 18.93 | 5.90 | 1660 | 0.87 | 78.0 | 0.21 |

TABLE 2
BLOCK COMPOSITE MATE

| | | S_{BET}, | W₀ | Quantity of | | | Composite material properties | | | | | |
|---|---|---|---|---|---|---|---|---|---|---|---|---|
| Composite | | OMCP, | OMCP, | additional | P, | t, | ρ, | S_{BET}, | W₀, | D₁/D₂, | HA, | HB, |
| No. | OMCP | m²/g | cm³/g | components, % | kN | min | g/cm³ | m²/g | cm³/g | nm | ShA | kg/mm² |
| F-16 | Cu-BTC | 880 | 0.37 | +T-6 50:50 +5% | 50 | 1 | 0.76 | 800 | 0.32 | 0.70/1.22 | 95.5 | 0.60 |
| | | | | PVAL sol. 1:1 | | | | | | | | |
| F-17 | Cu-BTC | 880 | 0.37 | +T-6 70:30 +5% | 50 | 1 | 0.73 | 870 | 0.36 | 0.68/1.20 | 91.0 | 0.73 |
| | | | | PVAL sol. 1:1 | | | | | | | | |
| F-18 | Cu-BTC | 880 | 0.37 | +T-6 30:70 +5% | 50 | 1 | 0.65 | 940 | 0.38 | 0.67/1.19 | 84.0 | 0.46 |
| Example 1 | | | | PVAL sol. 1:1 | | | | | | | | |
| F-19 | Cu-BTC | 715 | 0.30 | +10% CNT +5% | 50 | 1 | 0.74 | 630 | 0.25 | 0.60/1.24 | 95.5 | 0.75 |
| | | | | PVAL 1:1 | | | | | | | | |
| F-20 | Cu-BTC | 715 | 0.30 | +5% CNT +5% | 50 | 1 | 0.85- | 720 | 0.30 | 0.56/1.22 | 84.5 | 0.70 |
| | | | | PVAL 1:1 | | | | | | | | |
| F-21 | Cu-BTC | 715 | 0.30 | +2% CNT +5% | 50 | 1 | 0.94 | 800 | 0.33 | 0.60/1.22 | 94.0 | 0.62 |
| | | | | PVAL 1:1 | | | | | | | | |
| F-22 | Cu-BTC | 715 | 0.30 | +50% T-1 +5% | 50 | 1 | 0.70 | 855 | 0.33 | 0.62/1.24 | 90.5 | 0.55 |
| | | | | PVAL 1:1 | | | | | | | | |
| F-23 | Cu-BTC | 880 | 0.37 | +30% T-1 +5% | 50 | 1 | 0.78 | 740 | 0.29 | 0.60/1.25 | 90.5 | 0.51 |
| | | | | PVAL 1:1 | | | | | | | | |
| F-24 | Cu-BTC | 880 | 0.37 | +70% T-1 +5% | 50 | 1 | 0.70 | 855 | 0.32 | 0.61/1.24 | 92.5 | 0.75 |
| | | | | PVAL 1:1 | | | | | | | | |
| F-27 | Cu-BTC | 725 | 0.30 | +10% CNT +5% | 75 | 1 | 0.77 | 740 | 0.29 | 0.60/1.18 | 94.0 | 0.60 |
| Example 3 | | | | PVAL 1:1 | | | | | | | | |
| F-39 | Al-BTC | 1300 | 0.56 | +70% T-6 +5% | 50 | 2 | 0.59 | 1,075 | 0.40 | 1.16/1.70 | 25.0 | 0.12 |
| | | | | PVAL 1:1 | | | | | | | | |
| F-40 | Al-BTC | 1325 | 0.50 | +70% T-1 +5% | 50 | 2 | 0.60 | 1,040 | 0.41 | 1.24/1.68 | 20.0 | 0.13 |
| | | | | PVAL 1:1 | | | | | | | | |
| F-41 | Al-BTC | 1325 | 0.50 | +50% T-6 +5% | 75 | 2 | 0.65 | 500 | 0.21 | 1.18/1.77 | 50.0 | 0.25 |
| Example 2 | | | | PVAL 1:1 | | | | | | | | |
| F-42 | Al-BTC | 1300 | 0.49 | +30% T-1 +5% | 50 | 2 | 0.67 | 380 | 0.15 | 1.23/1.70 | 20.0 | 0.12 |
| | | | | PVAL 1:1 | | | | | | | | |
| F-63 | Al-BTC | 1300 | 0.49 | +70% T-1 +5% | 75 | 2 | 0.58 | 895 | 0.36 | 1.22/1.72 | 79.5 | 0.48 |
| | | | | PVAL 1:1 | | | | | | | | |
| F-64 | Al-BTC | 1300 | 0.49 | +60% T-1 +5% | 75 | 2 | 0.57 | 780 | 0.30 | 1.24/1.74 | 85.5 | 0.52 |
| | | | | PVAL 1:1 | | | | | | | | |
| F-65 | Al-BTC | 1300 | 0.49 | 50% T-1 +5% | 75 | 2 | 0.54 | 660 | 0.27 | 1.25/1.74 | 89.5 | 0.59 |
| | | | | PVAL 1:1 | | | | | | | | |
| F-111 | Cu-BTC | 750 | 0.35 | +50% T-6 +2% | 50 | 1 | 0.76 | 800 | 0.36 | 0.66/1.18 | 65.0 | 0.30 |
| Example 4 | | | | chitosan 1:1 | | | | | | | | |
| F-116 | Cu-BTC | 750 | 0.35 | +50% T-6 +2% | 75 | 1 | 1.22 | 840 | 0.37 | 0.67/1.19 | 45.0 | 0.20 |
| Example 5 | | | | oxycellulose 1:1 | | | | | | | | |

1. A method of block composite material production for accumulation of gases comprising mixing of components with binder, molding of the obtained mixture into blocks; and subsequent drying of the blocks,
wherein:
organometallic coordination polymer and nanoporous carbon adsorbent or adsorbent on the basis of carbon nanotubes, which are mixed in ratio from 30/70 to 95/5% wt, are used as components;
effective inner diameters of micropores of the mixed components differ from one another by 0.4 nm minimum and 0.8 nm maximum;
2-15% water solution of compounds like polyvinyl alcohol, chitosan solution in acetic acid, oxyethylcellulose is used as binder;
the obtained mixture is molded under the pressure into blocks within 1-2 minutes with loading force from 25 to 75 kN;
blocks are placed in drying chamber at normal conditions;
thereafter temperature is increased to 110-120° C. with a rate of 60 deg/h maximum and dry for 12 h minimum and 36 h maximum; and
then blocks are activated in thermal vacuum chamber at a temperature of 120° C. during 6 h minimum at a residual pressure of 0.26 kPa.

2. A block composite material for gas accumulation containing organometallic coordination polymer, nanoporous carbon adsorbent or adsorbent on the basis of carbon nanotubes in ratio from 30/70 to 95/5% wt respectively and binder, 2-15% water solution of compounds like polyvinyl alcohol, chitosan solution in acetic acid, oxyethylcellulose, characterized in that pour density of block composite material is in the range from 0.540 to 1.220 g/cm³, nanoporous structures is bimodal, effective inner diameters of micropores are comparable with initial components and differ from one another by 0.4 nm minimum and 0.8 nm maximum, material is used at temperatures from minus 30 to plus 60° C. and pressures of up to 10 MPa.
